(19) United States
(12) Patent Application Publication
(10) Pub. No.: US 2010/0323289 A1
(43) Pub. Date: Dec. 23, 2010

(54) Chemical toners comprising modified pigments

(76) Inventors: Joseph B. Carroll, Glen Allen, VA (US); Qingling Zhang, Billerica, MA (US)

Correspondence Address: Cabot Corporation/FinchMaloney, Cabot Corporation, Law Department, 157 Concord Road, Billerica, MA, 01821, US

(21) Appl. No.: 12/802,865

(22) Filed: Jun. 16, 2010

Related U.S. Application Data
(60) Provisional application No. 61/269,069, filed on Jun. 19, 2009.

(51) Int. Cl. G03G 9/09; G03G 9/08

(52) U.S. Cl. 430/108.2; 430/105; 430/108.1; 430/108.4; 430/108.5

(57) ABSTRACT

The present invention relates to chemical toner compositions comprising a resin and a polymer modified pigment comprising a pigment having attached at least one polymeric group. The polymer modified pigment comprises the reaction product or combination product of a modified pigment comprising the pigment having attached at least one organic group which comprises at least one first functional group, and at least one polymer comprising at least one second functional group.

### CROSS-REFERENCE TO RELATED APPLICATIONS

This application claims the benefit of U.S. Provisional Patent Application Ser. No. 61/269,069, filed Jun. 19, 2009 and entitled CHEMICAL TONERS COMPRISING MODIFIED PIGMENTS, which is fully incorporated herein by reference.

### BACKGROUND OF THE INVENTION

1. Field of the Invention

The present invention relates to chemically prepared toner compositions comprising polymer modified pigments.

2. Description of the Related Art

Electrophotographic processes and image-forming apparatuses are currently widespread. In electrophotography, an image comprising an electrostatic field pattern (also referred to as an electrostatic latent image), usually of non-uniform strength, is formed on an insulative surface of an electrophotographic element. The insulative surface typically comprises a photoconductive layer and an electrically conductive substrate. The electrostatic latent image is then developed or visualized into an image by contacting the latent image with a toner composition. Generally, the toner composition contains a resin and a colorant, such as a pigment. The toner image is then transferred onto a transfer medium such as paper and fixed thereon by heating and/or pressure. The last step involves cleaning residual toner from the electrophotographic element.

In general, conventional dry toner compositions are prepared by combining a polymeric resin and a colorant followed by mechanical grinding (particle size attrition). The grinding process typically results in uncontrolled breakage of the particles, yielding toner compositions having irregular shapes with relatively wide particle size distributions.

There is a growing need in the industry for toner compositions that can produce images having improved print quality using lower amounts of dry toner per page. In order to meet these needs, efforts have been made to improve the dispersibility of the colorant in the resin and reducing the overall particle size of the toner composition. However, the current mechanical grinding processes are not able to efficiently produce small particle size toners since the energy consumed in grinding typically increases exponentially with the particle size. Also, the irregularly shaped conventional toner particles cannot pack as well as regularly shaped particles, resulting in higher waste of toner per page.

For this reason, various processes have been developed which produce toner particles having small and/or regular shapes. These processes involve the formation of resin particles in the presence of the colorant. Toners produced using such “in situ” processes are often referred to as “chemically prepared toners” (CPTs) or chemical toners. For example, a process has been developed in which a polymer latex is combined with an aqueous pigment dispersion and agglomerated using a coagulant to form polymer particles. Another process involves the aqueous suspension polymerization of a dispersion of pigment in at least one monomer. Also, a pigment/polyester resin dispersion has been prepared and combined with water, followed by evaporation of the solvent. Each of these processes result in small particle size toner compositions having regular shapes. However, for each of these processes, since smaller particles result, the dispersibility of the colorant in the polymer becomes very important in order to maintain or improve the properties of the toner. To provide good dispersibility, high levels of dispersants may be included in the chemical toner processes which may have a negative impact on the overall performance of the toner composition, particularly the viscosity of the mixtures used to prepare the toners, charging, and/or the moisture sensitivity of the resulting chemical toner. Other issues have also been found.

Modified pigments having attached organic groups have been disclosed for use in toner compositions. For example, U.S. Pat. No. 6,218,067 discloses, in part, a toner composition comprising the product of a mixture of resin particles and chargeable modified pigment particles. The modified pigment particles comprise at least one organic ionic group attached to the pigment particles and at least one amphiphilic counterion. Also, U.S. Pat. Nos. 5,955,232 and 6,054,238 disclose, in part, toner compositions comprising resin particles and modified pigment particles having attached at least one positively chargeable organic group. In addition, U.S. Pat. No. 6,929,889 discloses, in part, a modified pigment product comprising a pigment having attached at least one organic group represented by the formula -X-Sp-Alk, wherein X, which is directly attached to the pigment, represents an arylene, heteroarylene, or alkylene group, Sp represents a spacer group, and Alk represents an alkenyl or alkyl group containing 50-200 carbon atoms. Toner compositions are also disclosed. Furthermore, U.S. Pat. Nos. 6,337,358, 6,372,820 and 6,664,312 disclose, in part, toner compositions comprising modified particles having attached polymeric groups. Modified pigments having specific attached groups have also been disclosed for use in toner, and, in particular, in chemical toners, in U.S. Patent Publication Nos. 2006-0172212 and 2008-0305422.

While the materials disclosed in these patents and publications provide toner compositions having good overall performance, there remains a need for toners, in particular chemical toners, with properties capable of meeting the increasingly demanding print performance, efficiency, and cost requirements of the industry.

### SUMMARY OF THE INVENTION

In one aspect a chemical toner composition is provided, the composition comprising a resin and a polymer modified pigment comprising a pigment having attached at least one polymeric group, wherein the polymer modified pigment comprises the reaction product of a modified pigment comprising the pigment having attached at least one organic group, wherein the organic group comprises at least one first functional group, and at least one polymer comprising at least one second functional group, wherein the first functional group of the modified pigment and the second functional group of the polymer react to form the polymer modified pigment.

In some embodiments, the first functional group of the modified pigment is an electrophilic group and the second functional group of the polymer is a nucleophilic group, or the first functional group of the modified pigment is a nucleophilic group and the second functional group of the polymer is an electrophilic group. In another embodiment the first functional group of the modified pigment is an electrophilic group and the second functional group of the polymer is a nucleophilic group. In another embodiment the first functional group of the modified pigment is a nucleophilic group and the second functional group of the polymer is an electrophilic group.

In another embodiment of a chemical toner composition the first functional group of the modified pigment and the second functional group of the polymer are independently selected from the group consisting of: a carboxylic acid; an ester; an acid chloride; a sulfonyl chloride; an acyl azide; an isocyanate; a ketone; an aldehyde; an anhydride; an amide; an imide; an imine; an α,β-unsaturated ketone, aldehyde, or sulfone; an alkyl halide; an epoxide; an alkyl sulfonate or sulfate; an aromatic compound which is capable of undergoing an addition-elimination reaction; an amine; a hydrazine; an alcohol; a thiol; a hydrazide; an oxime; a triazene; a carbanion; and a salt or derivative thereof. In another embodiment of the chemical toner composition the first functional group of the modified pigment and the second functional group of the polymer react to form an addition-elimination product between the modified pigment and the polymer.

In another embodiment of the chemical toner composition the first functional group of the modified pigment is an alkyl sulfate group and the second functional group of the polymer is an amino group. The alkyl sulfate group can be a (2-sulfatoethyl)-sulphone group. The organic group can be a phenyl-(2-sulfatoethyl)-sulphone group.

In another set of embodiments, the chemical toner composition can include a composition wherein the first functional group of the modified pigment and the second functional group of the polymer react to form a condensation product between the modified pigment and the polymer. In one embodiment, the first functional group of the modified pigment is an amino group and the second functional group of the polymer is a carboxylic acid group, and the condensation product is an amide. In another embodiment the first functional group of the modified pigment is a carboxylic acid group and the second functional group of the polymer is an amino group, and the condensation product is an amide. In another embodiment the first functional group of the modified pigment is an alcohol group and the second functional group of the polymer is a carboxylic acid group, and the condensation product is an ester. In another embodiment the first functional group of the modified pigment is a carboxylic acid group, the second functional group of the polymer is an alcohol group, and the condensation product is an ester.

In another set of embodiments, the chemical toner composition can include a composition wherein the first functional group of the modified pigment is an anionic or anionizable group and the second functional group of the polymer is a cationic or cationizable group, or the first functional group of the modified pigment is a cationic or cationizable group and the second functional group of the polymer is an anionic or anionizable group. In a further embodiment, the first functional group of the modified pigment is cationizable and the second functional group of the polymer is anionizable. In another embodiment the first functional group of the modified pigment is anionizable and the second functional group of the polymer is cationizable. In another embodiment the first functional group of the modified pigment and the second functional group of the polymer react to form a salt between the modified pigment and the polymer. In a further embodiment first functional group of the modified pigment is a sulfonic acid group or a carboxylic acid group and the second functional group of the polymer is an amino group, and wherein the salt is an ammonium salt. In another embodiment of the chemical toner composition, the first functional group of the modified pigment is an amino group and the second functional group of the polymer is a sulfonic acid group or a carboxylic acid group and the salt is an ammonium salt. In a further embodiment the polymer is an amine-terminated polymer. In still another embodiment the polymer is an amine-terminated polyalkylene oxide. In another embodiment, the polymer is the resin.

In another aspect, a chemical toner composition is provided, the composition comprising a resin and a polymer modified pigment comprising a pigment having attached at least one polymeric group, wherein the polymer modified pigment comprises the combination product of a modified pigment comprising the pigment having attached at least one organic group, wherein the organic group comprises at least one first functional group, and at least one polymer comprising at least one second functional group, wherein the first functional group of the modified pigment and the second functional group of the polymer coordinate with each other to form the polymer modified pigment and wherein the first functional group of the modified pigment is an anionic group and the second functional group of the polymer is a cationizable group, or the first functional group of the modified pigment is a cationizable group and the second functional group of the polymer is an anionic group. In a further embodiment, the first functional group of the modified pigment and the second functional group of the polymer coordinate to form an associated ion pair between the modified pigment and the polymer. In another embodiment the first functional group of the modified pigment is a sulfonic acid salt group and the second functional group of the polymer is an amino group. In a further defined embodiment the sulfonic acid salt group has the formula —SO₃⁻M⁺, wherein M⁺ is Na⁺, K⁺, Li⁺, Cs⁺, Ca⁺², Cu⁺², Zn⁺², Fe⁺², Fe⁺³, or Zr⁺⁴.

In another aspect, a chemical toner composition is provided, the composition comprising a resin and a polymer modified pigment comprising a pigment having attached at least one polymeric group, wherein the polymeric group has the formula -X-Z-[PAO]-R, wherein X, which is directly attached to the pigment, is an arylene or heteroarylene group; Z is NR′ or O and R′ is H, a C1-C18 alkyl group, a C1-C18 acyl group, an aralkyl group, an alkaryl group, or an aryl group; PAO is a polyalkylene oxide group; and R is H, a substituted or unsubstituted alkyl group, or a substituted or unsubstituted aromatic group. In a more specific embodiment X is an arylene group. In another embodiment the PAO is a copolymer of ethylene oxide and propylene oxide. In a further embodiment, Z is NH.

It is to be understood that both the foregoing general description and the following detailed description are exemplary and explanatory only and are intended to provide further explanation of the present invention, as claimed.

### DESCRIPTION OF THE DRAWINGS

FIGS. 1-4 illustrate the color performance of various chemically prepared toner compositions consistent with at least one embodiment of the present disclosure;

FIGS. 5-11 illustrate compatibility results of various chemically prepared toner compositions consistent with at least one embodiment of the present disclosure; and

FIGS. 12-14 illustrate compatibility results of various comparative examples.

### DETAILED DESCRIPTION OF THE INVENTION

The present invention relates to chemical toner compositions comprising a polymer modified pigment.

The toner compositions of the present invention are “chemical toners” or “chemically prepared toners” (CPTs), which, as defined herein, are toners having small and/or regular shapes. Contrary to conventional toner compositions, which are produced by combining a resin and a colorant followed by pulverization, chemical toners are typically prepared by processes involving the formation of toner particles in the presence of a colorant and a solvent, such as an aqueous solvent, and do not require the use of a pulverization step. Current mechanical grinding processes used to prepare conventional toner compositions are not able to efficiently produce small particle size toners since the energy consumed in grinding typically increases exponentially with the particle size. Also, irregularly shaped particles result from the conventional grinding processes, which cannot pack as well as regularly shaped particles, resulting in higher waste of toner per page. The toner compositions of the present invention are chemical toners having small and/or regular shapes since the particles are not produced using a pulverization step, as in conventional toner compositions.

The resin of the chemical toner of the present invention may be any resin known in the art. Suitable resin materials include, for example, polyamides, polyolefins, polycarbonates, styrene acrylates, styrene methacrylates, styrene butadienes, crosslinked styrene polymers, epoxies, polyurethanes, vinyl resins, including homopolymers or copolymers of two or more vinyl monomers, polyesters and mixtures thereof. In particular, the resin may include homopolymers of styrene and its derivatives and copolymers thereof such as polystyrene, poly-p-chlorostyrene, polyvinyltoluene, styrene-p-chlorostyrene copolymers, styrene-vinyltoluene copolymers, copolymers of styrene and acrylic acid esters such as methyl acrylate, ethyl acrylate, -n-butyl acrylate, and 2-ethylhexyl acrylate, copolymers of styrene and methacrylic acid esters such as methyl methacrylate, ethyl methacrylate, n-butyl methacrylate, and 2-ethylhexyl methacrylate, copolymers of styrene, acrylic acid esters and methacrylic acid esters, or copolymers of styrene with other vinyl monomers such as acrylonitrile (styrene-acrylonitrile-indene copolymers), vinyl methyl ether, butadiene, vinyl methyl ketone, and maleic acid esters. The resin may also be a polymethyl methacrylate resin, polybutyl methacrylate resin, a polyvinyl acetate resin, a polyvinyl butyral resin, a polyacrylic acid resin, a phenolic resin, an aliphatic or alicyclic hydrocarbon resin, a petroleum resin, or a chlorin paraffin. The resin may also be a polyester resin, such as copolyesters prepared from terephthalic acid (including substituted terephthalic acid), a bis[(hydroxyalkoxy)phenyl]alkane having from 1 to 4 carbon atoms in the alkoxy radical and from 1 to 10 carbon atoms in the alkane moiety (which can also be halogen-substituted alkane), and alkylene glycol having from 1 to 4 carbon atoms in the alkylene moiety. Any of these resin types may be used either individually or as mixtures with these or other resins.

The resin is generally present in an amount between about 60% and about 95% by weight of the total chemical toner composition. Generally, resins particularly suitable for use in xerographic toner manufacturing have a melting point in the range of between about 100° C. and about 135° C. and have a glass transition temperature (Tg) greater than about 60° C.

The chemical toner composition of the present invention also comprises a polymer modified pigment, which comprises a pigment having attached at least one polymeric group. The pigment of this polymer modified pigment can be any type of pigment conventionally used by those skilled in the art, such as black pigments and other colored pigments including blue, black, brown, cyan, green, white, violet, magenta, red, orange, or yellow pigments. Mixtures of different pigments can also be used. Representative examples of black pigments include various carbon blacks (Pigment Black 7) such as channel blacks, furnace blacks and lamp blacks, and include, for example, carbon blacks sold under the Regal®, Black Pearls®, Spheron®, Sterling®, and Vulcan® trademarks available from Cabot Corporation, the Raven®, Statex®, Furnex®, and Neotex® trademarks and the CD and HV lines available from Columbian Chemicals, and the Corax®, Durax®, Ecorax®, and Purex® trademarks and the CK line available from Evonik (Degussa) Industries. Suitable classes of colored pigments include, for example, anthraquinones, phthalocyanine blues, phthalocyanine greens, diazos, monoazos, pyranthrones, perylenes, heterocyclic yellows (including diarylides and disazo condensation pigments), naphthol-AS's, quinacridones, and (thio)indigoids. Such pigments are commercially available in either powder or press cake form from a number of sources including, BASF Corporation, Engelhard Corporation and Sun Chemical Corporation. For example, the colored pigment can be a cyan pigment such as Pigment Blue 15, PB 15, 15:1, 15:2, 15:3, 15:4, 15:6, or Pigment Blue 60, a magenta pigment such as Pigment Red 122, Pigment Red 170, Pigment Red 177, Pigment Red 185, Pigment Red 187, Pigment Red 202, Pigment Red 238, Pigment Red 269, a violet pigment such as Pigment Violet 19 or Pigment Violet 25, a yellow pigment such as Pigment Yellow 1, Pigment Yellow 3, Pigment Yellow 12, Pigment Yellow 13, Pigment Yellow 13, Pigment Yellow 14, Pigment Yellow 17, Pigment Yellow 65, Pigment Yellow 73, Pigment Yellow 74, Pigment Yellow 128, Pigment Yellow 139, Pigment Yellow 151, Pigment Yellow 155, Pigment Yellow 180, Pigment Yellow 185, Pigment Yellow 218, Pigment Yellow 220, or Pigment Yellow 221, an orange pigment such as Pigment Orange 38 or Pigment Orange 168, or a green pigment such as Pigment Green 7 or Pigment Green 36. Examples of other suitable colored pigments are described in the Colour Index, 3rd edition (The Society of Dyers and Colourists, 1982).

The pigment of the polymer modified pigment may also be a multiphase aggregate comprising a carbon phase and a silicon-containing species phase or a multiphase aggregate comprising a carbon phase and a metal-containing species phase. The multiphase aggregate containing the carbon phase and the silicon-containing species phase can also be considered a silicon-treated carbon black aggregate and the multiphase aggregate containing a carbon phase and a metal-containing species phase can be considered to be a metal-treated carbon black aggregate as long as one realizes that in either case, the silicon-containing species and/or metal-containing species are a phase of the aggregate just like the carbon phase. The multiphase aggregates do not represent a mixture of discrete carbon black aggregates and discrete silica or metal aggregates and are not silica coated carbon blacks. Rather, the multiphase aggregates that can be used as the pigment in the present invention include at least one silicon-containing or metal-containing region concentrated at or near the surface of the aggregate (but put of the aggregate) and/or within the aggregate. The aggregate, thus contains at least two phases, one of which is carbon and the other of which is a silicon-containing species, a metal-containing species, or both. The silicon-containing species that can be a part of the aggregate is not attached to a carbon black aggregate like a silica coupling agent, but actually is part of the same aggregate as the carbon phase.

The metal-treated carbon blacks are aggregates containing at least a carbon phase and a metal-containing species phase. The metal-containing species can include compounds containing cobalt, nickel, chromium, or iron, which provide magnetic properties to the toner composition. The metal-containing species phase can be distributed through at least a portion of the aggregate and is an intrinsic part of the aggregate. The metal-treated carbon black may also contain more than one type of metal-containing species phase. Further, the metal-treated carbon black may also contain a silicon-containing species phase.

The details of making these multiphase aggregates are explained in U.S. Pat. Nos. 5,830,930; 5,877,238; 5,904,762; 5,948,835; 6,028,137; 6,017,980; and 6,057,387. All of these patent applications are hereby incorporated in their entireties herein by reference.

A silica-coated carbon product can also be used as the pigment, such as that described in PCT Application No. WO 96/37547, published Nov. 28, 1996, which is hereby incorporated in its entirety herein by reference.

The pigment of the polymer modified pigment may also be a pigment that has been oxidized using an oxidizing agent in order to introduce ionic and/or ionizable groups onto the surface. Oxidized pigments prepared in this way have been found to have a higher degree of oxygen-containing groups on the surface. Oxidizing agents include, but are not limited to, oxygen gas, ozone, peroxides such as hydrogen peroxide, persulfates, including sodium and potassium persulfate, hypohalites such a sodium hypochlorite, oxidizing acids such a nitric acid, and transition metal containing oxidants, such as permanganate salts, osmium tetroxide, chromium oxides, or ceric ammonium nitrate. Mixtures of oxidants may also be used, particularly mixtures of gaseous oxidants such as oxygen and ozone. Other surface modification methods, such as chlorination and sulfonylation, may also be used, to introduce ionic or ionizable groups.

The pigment of the polymer modified pigment can have a wide range of BET surface areas, as measured by nitrogen adsorption, depending on the desired properties of the pigment. For example, the pigment may be a carbon black having a surface area of from about 10 to 600 m²/g, such as from about 20 to 250 m²/g or about 20 to 100 m²/g. As known to those skilled in the art, a higher surface area will typically correspond to a smaller primary particle size. The pigment can also have a wide variety of primary particle sizes known in the art. For example, the pigment may have a primary particle size of between about 5 nm to about 100 nm, including about 10 nm to about 80 nm or 15 nm to about 50 nm. If, for example, a higher surface area for a colored pigment is not readily available for the desired application, it is also well recognized by those skilled in the art that the pigment may be subjected to conventional size reduction or comminution techniques, such as ball or jet milling, to reduce the pigment to a smaller particle size, if desired.

The pigment of the polymer modified pigment can also have a wide range of dibutylphthalate absorption (DBP) values, which is a measure of the structure or branching of the pigment. For example, the pigment may be a carbon black having a DBP value of from about 30 to 100 mL/100 g, including from about 40 to 90 mL/100 g or from about 50 to 80 mL/100 g. In addition, the pigment may have a wide range of primary particle sizes, such as from about 10 to 100 nm, including from about 15 to 60 nm.

The polymer modified pigment of the chemical toner composition of the present invention comprises either the reaction product or combination product of a modified pigment and at least one polymer. The modified pigment comprises a pigment having attached at least one organic group. The pigment of the modified pigment can be any of those described above for the polymer modified pigment. The organic group of the modified pigment comprises at least one first functional group, and the polymer comprises at least one second functional group. Each of these is discussed in more detail below.

As used herein, the term “reaction product” means that the polymer modified pigment is the product that results when the modified pigment and the polymer react with each other, such as through a covalent or an ionic reaction. The term “combination product” means that the polymer modified pigment is the product resulting from combining the modified pigment and the polymer such that the modified pigment and the polymer interact with each other, such as through association or coordination. This may also result in a further reaction of these components. For example, the polymer modified pigment may be the reaction product of a modified pigment comprising a pigment having attached at least one organic group, wherein the organic group comprises at least one first functional group, and at least one polymer comprising at least one second functional group. For this example, the first functional group of the modified pigment reacts with the second functional group of the polymer, thereby forming the polymer modified pigment. As an additional example, the polymer modified pigment may be the combination product of a modified pigment comprising a pigment having attached at least one organic group, wherein the organic group comprises at least one first functional group, and at least one polymer comprising at least one second functional group, wherein the first functional group of the modified pigment and the second functional group of the polymer coordinate or associate with each other, thereby forming the polymer modified pigment.

The first functional group of the modified pigment and the second functional group of the polymer can be any groups capable of reacting or interacting with each other. For example, the first functional group may be a nucleophilic group and the second functional group may be an electrophilic group, or vice versa. Thus, for example, the nucleophilic or electrophilic group may be a carboxylic acid, an ester, an acid chloride, a sulfonyl chloride, an acyl azide, an isocyanate, a ketone, an aldehyde, an anhydride, an amide, an imide, an imine, an α,β-unsaturated ketone, aldehyde, or sulfone, an alkyl halide, an epoxide, an alkyl sulfonate or sulfate such as a (2-sulfatoethyl)-sulfone group, an amine, a hydrazine, an alcohol, a thiol, a hydrazide, an oxime, a triazene, a carbanion, an aromatic compound (especially one that is capable of undergoing an addition-elimination reaction), or a salt or derivative thereof. Preferably, the first and second functional groups are independently a carboxylic acid group, an anhydride group, an amine group (such as an alkyl amine group, including a benzylamine, phenylethylamine, phenyleneamine, or aminoalkylamine group such as an —SO₂-ALK1-NH-ALK2-NH₂ group wherein ALK1 and ALK2, which can be the same or different, are C2-C8 alkylene groups), an alkyl sulfate group, or a salt thereof.

As a specific example, the first functional group of the modified pigment and the second functional group of the polymer can react to form an addition-elimination product between the modified pigment and the polymer. Such a reaction product can result when the first functional group of the modified pigment is an alkyl sulfate group (such as a (2-sulfatoethyl)-sulphone group or, more specifically, a phenyl-(2-sulfatoethyl)-sulphone group), as an electrophilic group, and the second functional group of the polymer is an amino group, as a nucleophilic group.

As an additional specific example, the first functional group of the modified pigment and the second functional group of the polymer can react to form a condensation product between the modified pigment and the polymer. Such a reaction product can result when the first functional group of the modified pigment is an amino group and the second functional group of the polymer is a carboxylic acid group, or vice versa. The resulting condensation product would therefore be an amide. Alternatively, such a product can also result when the first functional group of the modified pigment is an alcohol group and the second functional group of the polymer is a carboxylic acid group, or vice versa. The resulting condensation product would therefore be an ester.

Also, both the first functional group and the second functional group may be an ionic group or an ionizable group. An ionic group is either anionic or cationic and is associated with a counterion of the opposite charge including inorganic or organic counterions such as H⁺, Na⁺, K⁺, Li⁺, NH₄⁺, NR₄⁺, acetate, NO₃⁻, SO₄⁻², RSO₃⁻, ROSO₃⁻, OH⁻, and Cl⁻, where R represents hydrogen or an organic group such as a substituted or unsubstituted aryl and/or alkyl group. An ionizable group is one that is capable of forming an ionic group in the medium of use.

Thus, for example, the first functional group may be an anionic or anionizable group and the second functional group may be a cationic or cationizable group, or vice versa. Anionic groups are negatively charged ionic groups that may be generated from groups having ionizable substituents that can form anions (anionizable groups), such as acidic substituents. They may also be the anion in the salts of ionizable substituents. Representative examples of suitable anionic groups include —COO⁻, —SO₃⁻, —OSO₃⁻, —HPO₃⁻, —OPO₃⁻², and —PO₃⁻², and representative examples of anionizable groups include —COOH, —SO₃H, —PO₃H₂, —R′SH, —R′OH, and —SO₂NHCOR′, where R′ represents hydrogen or an organic group such as a substituted or unsubstituted aryl and/or alkyl group. Cationic groups are positively charged organic ionic groups that may be generated from ionizable substituents that can form cations (cationizable groups), such as protonated amines. For example, alkyl or aryl amines may be protonated in acidic media to form ammonium groups —NR₂H⁺, where R represents an organic group such as a substituted or unsubstituted aryl and/or alkyl group.

As a specific example, the first functional group of the modified pigment and the second functional group of the polymer can react to form a salt between the modified pigment and the polymer. Such a reaction product can result when the first functional group of the modified pigment is a sulfonic acid group or a carboxylic acid group, as the anionic/anionizable group, and the second functional group of the polymer is an amino group, as the cationic/cationizable group, or vice versa. The resulting salt would be an ammonium salt.

As an additional specific example, the first functional group of the modified pigment and the second functional group of the polymer may coordinate to form an associated ion pair between the modified pigment and the polymer. Such a combination product can result when the first functional group of the modified pigment is an anionic group, such as a sulfonic acid salt group having the formula —SO₃⁻M⁺, and the second functional group of the polymer is a cationizable group, such as an amino group. In this formula, M+ can be, for example, Na⁺, K⁺, Li⁺, Cs⁺, Ca⁺², Cu⁺², Zn⁺², Fe⁺², Fe⁺³, or Zr⁺⁴. In addition, this combination product can result when the first functional group of the modified pigment is a cationizable group and the second functional group of the polymer is an anionic group.

As described above, the modified pigment comprises the pigment having attached at least one organic group, wherein the organic group comprises at least one first functional group. Preferably the organic group of the modified pigment is directly attached. The modified pigment can be prepared using any method known to those skilled in the art such that organic chemical groups are attached to the pigment. For example, the modified pigments can be prepared using the methods described in U.S. Pat. Nos. 5,554,739, 5,707,432, 5,837,045, 5,851,280, 5,885,335, 5,895,522, 5,900,029, 5,922,118, and 6,042,643, and PCT Publication WO 99/23174, the descriptions of which are fully incorporated herein by reference. Such methods provide for a more stable attachment of the groups onto the pigment compared to dispersant type methods, which use, for example, polymers and/or surfactants. Other methods for preparing the modified pigments include reacting a pigment having available functional groups with a reagent comprising the organic group, such as is described in, for example, U.S. Pat. No. 6,723,783, which is incorporated in its entirety by reference herein. Such functional pigments may be prepared using the methods described in the references incorporated above. In addition modified carbon blacks containing attached functional groups may also be prepared by the methods described in U.S. Pat. Nos. 6,831,194 and 6,660,075, U.S. Patent Publication Nos. 2003-0101901 and 2001-0036994, Canadian Patent No. 2,351,162, European Patent No. 1 394 221, and PCT Publication No. WO 04/63289, as well as in N. Tsubokawa, Polym. Sci., 17, 417, 1992, each of which is also incorporated in their entirety by reference herein.

The amount of the organic group, which comprises at least one first functional group, can be varied depending, for example, on the relative reactivity of the first and second functional groups. For example, the total amount of the organic group may be from about 0.01 to about 10.0 micromoles of organic group/m² surface area of pigment, as measured by nitrogen adsorption (BET method), including, for example, between from about 0.5 to about 4.0 micromoles/m². Additional attached organic groups which do not comprise at least one first functional group may also be used.

Also as described above, the polymer comprises at least one second functional group. A variety of different polymers can be used, and this forms the polymeric group of the polymer modified pigment. In particular, the polymer can be a homopolymer, copolymer, terpolymer, or can contain any number or arrangement of different repeating units, including a random polymer, alternating polymer, graft polymer, block polymer, hyperbranched or dendritic polymer, comb-like polymer, or any combination thereof. The polymer can have an average molecular weight (weight average molecular weight) of not greater than about 200,000. For example, the polymer can have an average molecular weight not greater than about 150,000, such as not greater than about 100,000, not greater than 50,000, or not greater than 20,000. The polymer can also have an average Molecular weight (weight average molecular weight) of at least about 500, such as at least about 1,000, at least 5,000, or at least 10,000. Also, the polymer may be in the form of a liquid, a powder, or a polymer melt, depending on the specific conditions used to prepare the polymer modified pigment.

Suitable examples of polymers comprising at least one functional group include polyamines, polyamides, polycarbonates, polyelectrolytes, polyesters, polyethers (such as polyalkyleneoxides), polyols (such as polyhydroxybenzenes and polyvinyl alcohols), polyimides, polymers containing sulfur (such as polyphenylene sulfides), acrylic polymers, polyolefins including those containing halogens (such as polyvinyl chlorides and polyvinylidene chlorides), fluoropolymers, polyurethanes, polyacids, or salts or derivatives thereof, or any combination thereof. The polymer can also be a polyanhydride, such as a polymer of maleic anhydride. In addition, the polymer can be the same as the resin used for the chemical toner of the present invention, described in more detail above.

Preferably, the second functional group of the polymer is on a terminus of the polymer, and, thus, the polymer is preferably a functional group-terminated polymer. For example, the polymer is preferably an amine-terminated polymer such as an amine-terminated polyalkylene oxide. Additional examples include polyamines, such as polyetheramines and polyethyleneimine (PEI) or derivatives thereof; oligomers of ethyleneimine (such as pentaethylenehexamine, PEHA) or derivatives thereof; polyamidoamine (PAMAM), such as Starburst® polyamidoamine dendrimers; or any combination thereof, each of which include a terminal amino group.

The amount of the polymer and the modified pigment will depend on a variety of factors, including the type and molecular weight of the polymer, the type of modified pigment, and the relative reactivities of the functional groups of the modified pigment and polymer. Preferably, the polymer modified pigment of the chemical toner composition of the present invention comprises the reaction or combination product of the polymer and the modified pigment in a weight ratio of between about 1:3 and about 9:1 modified pigment to polymer, such as between about 1:1 and about 6:1. More preferably, the weight ratio of modified pigment to polymer is between about 2:1 and about 4:1.

A preferred polymer modified pigment of the chemical toner composition of the present invention comprises a pigment having attached at least one polymeric group, wherein the polymeric group has the formula -X-Z-[PAO]-R. In this formula, X, which is directly attached to the pigment, is an arylene or heteroarylene group and is preferably an arylene group. Z is a heteratom-containing linking group such as NR′ or O, wherein R′ is H, a C1-C18 alkyl group, a C1-C18 acyl group, an aralkyl group, an alkaryl group, or an aryl group. Preferably, Z is NH. PAO is a polyalkylene oxide group and includes polymeric groups comprising alkylene oxide group having from about 1 to about 12 carbons, such as a —CH₂—CH₂—O— group, a —CH(CH₃)—CH₂—O— group, a —CH₂—CH(CH₃)—O— group, a —CH₂CH₂CH₂—O— group, or combinations thereof. Thus, PAO can be a copolymer of ethylene oxide and propylene oxide. R is a capping group of the polymeric group, such as H, a substituted or unsubstituted alkyl group, or a substituted or unsubstituted aromatic group. This polymer modified pigment can be the reaction product or combination of a modified pigment, which comprises a pigment having attached at least one organic group comprising at least one first functional group, and a polymer comprising at least one second functional group. The pigment and functional groups can be any of those described above. The polymer is a polyalkylene oxide, such as an amine-terminated polyalkylene oxide, which forms the polymeric group of the polymer modified pigment. The amount of the polymer and modified pigment can also be varied, as discussed in more detail above.

The toner composition of the present invention is a chemically prepared toner, also referred to as a chemical toner. Thus, the toner composition has a smooth surface, a mean particle size between about 3 and about 10 microns, or both. By smooth surface is meant that the toner has substantially no sharp or jagged edges, such as those that arise by the comminuting of large particles into smaller particles. The shape of the toner composition may be any having a smooth surface, but is preferably a shape having no corners or edges, such as spheroidal or ellipsoidal shape, including egg-shaped or potato-shaped. These 3-dimensional rounded shapes preferably have an aspect-ratio of about 1.0 to about 3.0, more preferably about 1.0 to about 2.0, and most preferably from about 1.2 to about 1.3.

The chemical toner composition of the present invention, comprising a resin and a polymer modified pigment, can be prepared using any method known in the art. For example, the chemical toner compositions can be prepared by a coagulation process comprising forming a coagulated toner comprising the resin and the polymer modified pigment and subsequently heating this mixture to a temperature above the T_{g} of the polymer, thereby forming the chemical toner. In this process, typically the coagulated toner is prepared by combining an aqueous dispersion, of the polymer modified pigment and an aqueous emulsion of the resin, along with at least one coagulant. An optional wax may also be added. Suitable coagulants include, for example, salts (such as polyaluminum chloride, polyaluminum sulfosilicate, aluminum sulfate, magnesium sulfate, or zinc sulfate), or surfactants, including cationic surfactants such as, dialkyl benzenealkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, C₁₂, C₁₅, or C₁₇ trimethyl ammonium bromides, the halide salts of quaternized polyoxyethylalkylamines, or dodecylbenzyl triethyl ammonium chloride. Mixtures of these may also be used. The coagulant, which can be used in an amount of, for example, from about 0.01 to about 10 percent by weight of toner, causes the formation of aggregated particles of resin and polymer modified pigment. Coagulation may also be caused by a change in pH. Thus, the coagulant may be an acid or a base, depending on the pH of the aqueous polymer modified pigment dispersion and/or the aqueous resin emulsion. In addition, the coagulated toner may be formed using mechanical or physical means. The resulting coagulated toner of this process is then heated above the T_{g} of the polymer for a time and temperature sufficient to form a chemical toner composition. Further details concerning specific aspects of this process can be found in, for example, U.S. Pat. Nos. 6,562,541, 6,503,680, and 5,977,210, all of which are incorporated in their entirety by reference herein.

The chemical toner composition of the present invention can also be prepared using a process comprising forming a dispersion of the polymer modified pigment in at least one monomer and suspending this dispersion in an aqueous medium, especially water. In this process, an initiator is also added, either in the polymer modified pigment dispersion or after forming the aqueous suspension, but is preferably added in the polymer modified pigment dispersion. Other optional components, such as stabilizers, may also be added. The resulting suspension is then polymerized to form the chemical toner comprising a resin and the polymer modified pigment. The monomer may be any of those used to prepare the resins described above for the chemical toner compositions of the present invention. Further details concerning specific aspects of this process can be found in, for example, U.S. Pat. Nos. 6,440,628, 6,264,357, 6,140,394, 5,741,618, 5,043,404, 4,845,007, and 4,601,968, all of which are incorporated in their entirety by reference herein.

The chemical toner composition of the present invention can also be prepared using a process comprising forming a dispersion of the polymer modified pigment in a resin solution comprising at least one non-aqueous solvent and at least one polyester resin, forming an aqueous emulsion of this dispersion in an aqueous medium, such as water, and evaporating the solvent to form the chemical toner. Other optional components, such as dispersing aids and emulsion stabilizers, may also be added, either in the modified pigment dispersion or after forming the aqueous emulsion. The polyester resin may be any of those used for preparing chemical toner compositions described in more detail above. Further details concerning specific aspects of this process can be found in, for example, U.S. Pat. Nos. 6,787,280 and 5,968,702, all of which are incorporated in their entirety by reference herein.

For each of these processes for forming the chemical toner composition, the chemical toner may also be encapsulated. Encapsulation results in the formation of a polymer shell around the toner, producing a chemical toner having a core/shell structure. Any process for encapsulation known the art can be used. The polymer used as the shell is chosen in order to provide performance and handling properties to the toner. For example, the resulting encapsulated toners may be more easily fused, particularly at lower temperatures, and may also have higher and more uniform charging characteristics. Other properties may also result. Also, for each of these processes, the chemical toner may be further purified. For example, the chemical toner compositions produced by the processes described above may be washed to remove undesired by-products or impurities and subsequently dried.

The chemical toner composition of the present invention may further comprise optional additives that may also be mixed or blended into one or more of the components used to prepare these compositions, described in more detail below. Examples include carrier additives, positive or negative charge control agents such as quaternary ammonium salts, pyridinium salts, sulfates, phosphates, and carboxylates, flow aid additives, silicone oils, or waxes such as commercially available polypropylenes and polyethylenes. The chemical toner composition can further comprise iron oxide, wherein the iron oxide can be magnetite, thus making the toner composition a magnetic toner composition. Generally, these additives are present in amounts of from about 0.05 by weight to about 30% by weight, however, lesser or greater amounts of the additives may be selected depending on the particular system and desired properties.

Surprisingly it has been found that polymer modified pigments, comprising the reaction product or combination product of a modified pigment comprising a pigment having attached at least one organic group, which further comprises at least one first functional group, and a polymer that comprises at least one second functional group, can be used to prepare chemical toner compositions having good overall properties. As described above, chemical toners are prepared using processes in which a colorant is dispersed in a medium, such as a solvent, and combined with a resin or resin precursor dispersion or solution. Thus, in order to form a chemical toner in which the colorant is well dispersed in the resin, the colorant must be dispersible in the medium as well as be compatible with the resin and resin precursor system. Furthermore, it must remain well dispersed as the chemical toner is formed. It would have been expected that, if a polymer modified pigment was well dispersed in and therefore highly compatible with the medium, this same polymer modified pigment would not also be readily dispersed in and compatible with the resin, including when forming the final chemical toner. Alternatively, if a polymer modified pigment was readily dispersible in the resin, it would not be expected that this same pigment would also be readily dispersible in the medium. It has been found that dispersibility in both the medium and the resin result in a chemical toner having improved overall properties, including improved hue, chroma, and/or image density, particularly compared to chemical toners prepared with a pigment that does not comprise an attached polymeric group (and thus is not a polymer modified pigment).

While not wishing to be bound by theory, the attributes of a surface modified pigment for incorporation into at least one embodiment of a chemical toner process consistent with the present disclosure may include the following. First, the modified pigment may be dispersible in an organic solvent, for example, down to the primary aggregate size (<200 nm). The pigment dispersion may also be able to be let down into the host resin system in solvent without flocculation or precipitation of the pigment. This host resin system could include a host of other additives such as waxes and charge control agents. For example, the surface modified pigment can be dispersed into a mixture of toner resin in ethyl acetate directly. Here, the host toner resin could include a range of low Tg polymers (such as, but not limited to, 40-80° C., for example, 50-70° C.) suitable for toner processing including polyesters, styrene acrylics, etc. After incorporation into the host resin in solution, the modified pigments may survive diverse toner formation process conditions which could include emulsification in water, exposure to ranges of surfactants, increasing vacuum, elevated temperatures, changes in concentrations during solvent removal, etc. All throughout these steps, the modified pigments stay well-dispersed in the toner resin without pigment migration into the water phase during the toner emulsification steps, without pigment flocculation within the toner particles after toner formation, without pigment migration to the interfaces during the toner formation process, etc.

The following are some examples consistent with at least one embodiment of the present disclosure.

### Example 1

### Acid/Base Approach

### A. Preparation of Polymer Modified Pigment

To 1009 g of Cab-O-Jet® 260M (Sulfanilic treated Pigment Red 122) at 10.00% solids was added 110 g of Amberlite IRN-77 acidic ion exchange resin (Supelco) and the contents were allowed to stir for 24 hours using simple overhead mixing. After 24 hr, the ion exchange resin was removed using a Gerson 2000™ fine mesh (190 micron) paint filter. To the viscous, acidified Cab-O-Jet® 260M slurry was then added 37.8 g of a monofunctional primary amine polyetheramine copolymer of propylene oxide/ethylene oxide having an average molecular weight of about 2,000 and a PO/EO mol ratio of 10/31 (Jeffamine® M-2070, Huntsman LLC). The mixture was allowed to stir for an additional 24 hours using an overhead stirrer. After 24 hr, the viscous slurry was placed in a heat-resistant glass tray and dried for 1-2 days at 70° C. Once dry, the crude was ground to a fine powder using a commercial coffee grinder.

### B. Preparation of Dispersion

### Skandex Milling of Polymer with Modified Pigment Red 122 (Acid Form)

13.75 g of a polymer modified pigment including a magenta pigment (Pigment Red 122, Sun Chemical) having attached sulfonic acid groups ion-exchanged with Jeffamine M-2070 polymer and 36.25 g ethyl acetate as solvent were metered into a 250 ml stainless steel paint can. To this was added 60 g of 2 mm glass beads, and a dispersion was prepared by mixing for six hours on a Skandex mixer. The resulting dispersion was very fluid and easily filterable. The glass beads were removed using a Gerson 2000™ fine mesh (190 micron) paint filter. The mean volume particle size (mV) of the particulate material in the dispersion was measured using a Microtrac® Particle Size Analyzer and found to be 0.121 μm, 0.109 μm d50, 0.229 μm d95.

### C. Preparation of Dispersion

Using an analogous procedure as that detailed in Example 1B and substituting a polyetheramine of nominal mol wt 2000 having a PO/EO ratio of about 29/6 (Jeffamine M-2005) in lieu of Jeffamine M-2070, the mean volume particle size (mV) of the particulate material in the dispersion was measured using a Microtrac® Particle Size Analyzer and found to be 0.132 μm, 0.118 μm d50, 0.247 μm d95.

### D. Comparative Example

### Skandex Milling of Conventional Dispersant with Unmodified Pigment Red 122

10 g of unmodified dry Pigment Red 122 (Sun Chemical, grade# 228-8228), 9.375 g Solsperse 32500 (Lubrizol) at 40% active solids (3.75 g dry basis), and 30.625 g Ethyl Acetate as solvent were metered into a 250 ml stainless steel paint can. To this was added 60 g of 2 mm glass beads, and a dispersion was prepared by mixing for six hours on a Skandex mixer. The resulting dispersion was viscous and difficult to filter. The glass beads were removed using a Gerson 2000™ fine mesh (190 micron) paint filter. The mean volume particle size (mV) of the particulate material in the dispersion was measured using a Microtrac® Particle Size Analyzer and found to be 0.320 μm, 0.294 μm d50, 0.566 μm d95.

### E. Comparative Example

Using an analogous procedure as that detailed in Example 1D and substituting Jeffamine M-2005 in lieu of Solsperse 32500, the mean volume particle size (mV) of the particulate material in the dispersion was measured using a Microtrac® Particle Size Analyzer and found to be 1.131 μm, 0.849 μm d50, 2.785 μm d95.

### F. Comparative Example

Using an analogous procedure to that detailed Example 1E and substituting Jeffamine M-2070 in lieu of Jeffamine M-2005, the mean volume particle size (mV) of the particulate material in the dispersion was measured using a Microtrac® Particle Size Analyzer and found to be 0.608 μm, 0.475 μm d50, 1.381 μm d95.

### G. Comparative Example

### Skandex Milling Surface Modified Pigment Red 122 in the Absence of a Polymeric Dispersant (Acid Form)

10 g of a surface modified pigment (Pigment Red 122, Sun Chemical) including a magenta pigment having attached sulfonic acid groups after having been ion exchanged with acidic resin and dried and 40 g Ethyl Acetate as solvent were metered into a 250 ml stainless steel paint can. To this was added 60 g of 2 mm glass beads, and a dispersion was prepared by mixing for six hours on a Skandex mixer. The resulting dispersion was poorly dispersed resulting in a highly viscous gel which was very difficult to filter. The glass beads were removed using a Gerson 2000™ fine mesh (190 micron) paint filter. The mean volume particle size (mV) of the particulate material in the dispersion was measured using a Microtrac® Particle Size Analyzer and found to be 1.291 μm, 1.269 μm d50, 1.833 μm d95.

### H. Comparative Example

### Skandex Milling Surface Modified Pigment Blue 15:4 in the Absence of a Polymeric Dispersant (Hydrophobic Diazonium)

10 g of a surface modified pigment including a cyan pigment (phthalocyanine Pigment Blue 15:4) having attached fluoroaniline groups (1.5 mmol/g pigment surface treatment) and 40 g Ethyl Acetate as solvent were metered into a 250 ml stainless steel paint can. To this was added 60 g of 2 mm glass beads, and a dispersion was prepared by mixing for six hours on a Skandex mixer. The resulting dispersion was noticeably viscous but became much more fluid upon shear. The glass beads were removed using a Gerson 2000™ fine mesh (190 micron) paint filter. The mean volume particle size (mV) of the particulate material in the dispersion was measured using a Microtrac® Particle Size Analyzer and found to be 0.596 μm, 0.574 μm d50, 0.816 μm d95.

### I. Preparation of Dispersion

### Rotostator Mixing of Polymer with Modified Pigment Red 122 (Acid Form)

15 g of a polymer modified pigment including a magenta pigment (Pigment Red 122) having attached sulfonic acid groups (diazonium treatment) ion-exchanged with Jeffamine M-2070 polymer and 85 g Ethyl Acetate as solvent were metered into a 250 ml glass beaker. A dispersion was prepared by mixing for 15 min using an IKA® T25 digital ULTRA-TURRA® mixer at 5000 rpm. The resulting dispersion was very fluid and easily filterable. The glass beads were removed using a Gerson 2000™ fine mesh (190 micron) paint filter. The mean volume particle size (mV) of the particulate material in the dispersion was measured using a Microtrac® Particle Size Analyzer and found to be 0.133 μm, 0.126 μm d50, 0.230 μm d95.

### J. Comparative Example

### Rotostator Mixing of Conventional Dispersant with Unmodified Pigment Red 122

10 g of a dried mixture of unmodified dry Pigment Red 122 (Sun Chemical, grade# 228-8228) and Solsperse 32500 (Lubrizol) in the same quantities as Example 1I and 73.66 g of Ethyl Acetate were metered into a 250 ml glass beaker. A dispersion was prepared by mixing for 15 min using an IKA® T25 digital ULTRA-TURRA® mixer at 5000 rpm. The resulting dispersion was poorly dispersed with the majority of the dried pigment settling to the bottom of the beaker upon rest. The glass beads were removed using a Gerson 2000™ fine mesh (190 micron) paint filter. The mean volume particle size (mV) of the particulate material in the dispersion was measured using a Microtrac® Particle Size Analyzer and found to be 0.774 μm, 0.478 μm d50, 4.51 μm d95.

### Example 2

### APSES Approach

### A. Preparation of Polymer Modified Pigment

To 1500 g of dry PB 15:3 (Phthalocyanine, Clariant toner grade, lot# DEBF009196) was added 6000 g of deionized water in a Ross mixer (20% solids in reaction). To this mixture was added 422 g aminophenylsulphone ethyl sulfonate (APSES, 1 mmol/g pigment) and the reaction mixture was brought to 60° C. To the reaction mixture was slowly added 103.5 g sodium nitrite (1 mmol/g pigment). The reaction was allowed to proceed for two to four hours. The crude APSES treated PB 15:3 was then divided into two equal portions wherein the first portion would remain crude throughout subsequent polymer attachment routes (crude) and the second portion (diafiltered) would be diafiltered to remove any unreacted starting materials and salts. The second portion of the APSES modified APSES-PB:13 dispersion in water was diafiltered with deionized water to a target permeate conductivity of <250 μs/cm and was subsequently concentrated to 14.39% final solids resulting in clean APSES modified PB 15:3 (diafiltered once). In the crude APSES modified PB 15:3 from the first portion (crude), final solids were determined to be 13.69%.

To 1500 g of crude APSES treated PB15:3 pigment (crude, from above) dispersion in water at 13.69% solids was added 77.0 g Jeffamine M-2070. The mixture was pH adjusted to 12.5 with sodium hydroxide and allowed to react for 24 hours with an overhead stirrer. In the first instance the crude mixture was allowed to tray dry at 70° C. overnight resulting in crude Jeffamine M-2070 treated APSES PB 15:3 (sample A1). In a second instance the crude Jeffamine M-2070 APSES PB15:3 was pH adjusted to pH 10 with hydrochloric acid followed by diafilteration to remove any unreacted polymer and salts. The Jeffamine M-2070 modified APSES-PB:13 dispersion in water was then diafiltered with deionized water to a target permeate conductivity of <250 μs/cm. The cleaned dispersion was then allowed to tray dry at 70° C. overnight resulting in Jeffamine M-2070 treated APSES PB 15:3 (sample A2).

To 1223.4 g of diafiltered APSES treated PB15:3 pigment (diafiltered, from above) dispersion in water at 14.39% solids was added 66.0 g Jeffamine M-2070. The mixture was pH adjusted to 12.5 with sodium hydroxide and allowed to react for 24 hours with an overhead stirrer. A first portion of the mixture was allowed to tray dry at 70° C. overnight resulting in Jeffamine M-2070 treated APSES PB 15:3 (sample B1). A second portion of the Jeffamine M-2070 APSES PB15:3 was pH adjusted to pH 10 with hydrochloric acid followed by diafiltration with deionized water to a target permeate conductivity of <250 μs/cm to remove any unreacted polymer and salts. The cleaned dispersion was allowed to tray dry at 70° C. overnight resulting in Jeffamine M-2070 treated APSES PB 15:3 (sample B2).

### B. Preparation of Dispersion

### Skandex Milling of Polymer Modified Apses Treated Pigment Blue 15:3, Sample B2

13.75 g of Jeffamine M-2070 modified APSES treated Pigment Blue 15:3 (sample B2) which was diafiltered twice (once after APSES diazonium reaction and once after Jeffamine M-2070 polymer attachment) and 36.25 g Ethyl Acetate as solvent were metered into a 250 ml stainless steel paint can. To this was added 60 g of 2 mm glass beads, and a dispersion was prepared by mixing for six hours on a Skandex mixer. The resulting dispersion was very fluid and easily filterable. The glass beads were removed using a Gerson 2000™ fine mesh (190 micron) paint filter. The mean volume particle size (mV) of the particulate material in the dispersion was measured using a Microtrac® Particle Size Analyzer and found to be 0.241 μm, 0.213 μm d50, 0.476 μm d95.

### C. Preparation of Dispersion

### Skandex Milling of Polymer Modified Apses Treated Pigment Blue 15:3, Sample B1

Using an analogous procedure as that detailed in Example 2B and substituting Jeffamine M-2070 modified APSES treated Pigment Blue 15:3 which was diafiltered after the APSES attachment step only (sample B1), the mean volume particle size (mV) of the particulate material in the dispersion was measured using a Microtrac® Particle Size Analyzer and found to be 0.176 μm, 0.165 μm d50, 0.295 μm d95.

### D. Preparation of Dispersion

### Skandex Milling of Polymer Modified Apses Treated Pigment Blue 15:3, Sample A2

Using an analogous procedure as that detailed in Example 2C and substituting Jeffamine M-2070 modified APSES treated Pigment Blue 15:3 which was diafiltered after the Jeffamine M-2070 attachment step only (sample A2), the mean volume particle size (mV) of the particulate material in the dispersion was measured using a Microtrac® Particle Size Analyzer and found to be 0.322 μm, 0.294 μm d50, 0.575 μm d95.

### E. Preparation of Dispersion

### Skandex Milling of Polymer Modified Apses Treated Pigment Blue 15:3 Sample A1

Using an analogous procedure as that detailed in Example 2D and substituting crude Jeffamine M-2070 modified APSES treated Pigment Blue 15:3 which was not diafiltered at all (sample A1), the mean volume particle size (mV) of the particulate material in the dispersion was measured using a Microtrac® Particle Size Analyzer and found to be 0.291 μm, 0.228 μm d50, 0.735 μm d95.

### F. Comparative Example

### Skandex Milling of Conventional Dispersant or Polymer with Unmodified Pigment Blue 15:3

10 g of unmodified dry Pigment Blue 15:3 (Sun Chemical, grade# 249-1284), 9.375 g Solsperse 32500 (Lubrizol) at 40% active solids (3.75 g dry basis), and 30.625 g Ethyl Acetate as solvent were metered into a 250 ml stainless steel paint can. To this was added 60 g of 2 mm glass beads, and a dispersion was prepared by mixing for six hours on a Skandex mixer. The resulting dispersion was viscous and difficult to filter. The glass beads were removed using a Gerson 2000™ fine mesh (190 micron) paint filter. The mean volume particle size (mV) of the particulate material in the dispersion was measured using a Microtrac® Particle Size Analyzer and found to be 0.861 μm, 0.620 μm d50, 2.655 μm d95.

### Example 3

### Thermal Condensation Approach

### A. Preparation of Polymer Modified Pigment (C1)

A PABA treated carbon black was produced by reacting para-aminobenzoic acid (PABA) with a stoichiometric amount of sodium nitrite to form the diazonium salt which was subsequently reacted with Regal® 330 (R330) pigment (Cabot Corp) to produce the PABA treated pigment. 50 g of dry PABA treated R330 (protonated acid form), 25 g Jeffamine M-2005, and 600 g of deionized water was allowed to stir for 30 min using an overhead stirrer. After 30 min, the mixture was placed in a heat-resistant glass tray and dried overnight at 165° C. The crude material was then stirred in a large stainless steel beaker containing 1500 g of deionized water. The pH of the slurry was then adjusted to pH 2 and the slurry was allowed to mix for 1-2 hours. After 1-2 hours mixing, the carbon black slurry was filtered and washed with additional volumes of water until pH of the wash water was pH>4. After the pH adjustment, the treated carbon black (sample C1) was placed was placed in a heat-resistant glass tray and dried for 1-2 days at 70° C. Thermal Gravimetric Analysis (TGA) of the resulting polymer modified carbon black showed 23.44% polymer attachment after an initial acidic wash (TGA 20.76% after 2^{nd} acidic wash).

### B. Comparative Example (C2)

50 g of dry PABA treated R330 (protonated acid form) as in Example 3A, above, 25 g Jeffamine M-2005, and 600 g of deionized water were allowed to stir for 30 min using an overhead stirrer. After 30 min, the mixture was placed in a heat-resistant glass tray and dried overnight at 70° C. The crude material was then stirred in a large stainless steel beaker containing 1500 g of deionized water. The pH of the slurry was then adjusted to pH 2 and the slurry was allowed to mix for 1-2 hours. After 1-2 hours mixing, the carbon black slurry was filtered and washed with additional volumes of water until the pH of the wash water was >4. After the pH adjustment, the treated carbon black (sample C2) was placed was placed in a heat-resistant glass tray and dried for 1-2 days at 70° C. Thermal Gravimetric Analysis (TGA) of the resulting polymer modified carbon black showed 7.65% polymer attachment after an initial acidic wash (TGA 6.77% after 2^{nd} acidic wash).

### C. Preparation of Dispersion (C1d)

### Skandex Milling of Jeffamine M-2005 Modified R330, Thermal Condensation at 165° C. (Sample C1)

13.062 g (at 23.44% polymer attachment, 10 g pigment) of Jeffamine M-2005 modified R330 thermally condensed at 165° C. (sample C1) and 36.93 g Ethyl Acetate as solvent were metered into a 250 ml stainless steel paint can. To this was added 60 g of 2 mm glass beads, and a dispersion was prepared by mixing for six hours on a Skandex mixer. The resulting dispersion was very fluid and easily filterable. The glass beads were removed using a Gerson 2000™ fine mesh (190 micron) paint filter. The mean volume particle size (mV) of the particulate material in the dispersion was measured using a Microtrac® Particle Size Analyzer and found to be 0.147 μm, 0.139 μm d50, 0.226 μm d95.

### D. Comparative Example (C2d)

### Preparation of Dispersion by Skandex Milling of Jeffamine M-2005 Modified R330, Thermal Condensation at 70° C. (Sample C2)

10.83 g (at 7.65% polymer attachment, 10 g pigment) of Jeffamine M-2005 modified R330 thermally condensed at 70° C. (sample C2) and 39.17 g ethyl acetate as solvent were metered into a 250 ml stainless steel paint can. To this was added 60 g of 2 mm glass beads, and a dispersion was prepared by mixing for six hours on a Skandex mixer. The resulting dispersion was very viscous and difficult to filter. The glass beads were removed using a Gerson 2000™ fine mesh (190 micron) paint filter. The mean volume particle size (mV) of the particulate material in the dispersion was measured using a Microtrac® Particle Size Analyzer and found to be 0.545 μm, 0.359 μm d50, 1.606 μm d95.

### Example 4

### Ion-Dipole (Analogous Procedure to Acid/Base)

### A. Preparation of Modified Pigment (D1)

To 927 g of Cab-O-Jet® 270Y (Sulfanilic acid treated Pigment Yellow 74, Na+ form) at 10.00% solids was added 92 g of Amberlite IRN-77 acidic ion exchange resin (Supelco) and the contents were allowed to stir for 24 hours using simple overhead mixing. After 24 h, the ion exchange resin was removed using a Gerson 2000™ fine mesh (190 micron) paint filter. The viscous slurry was then placed in a heat-resistant glass tray and dried for 1-2 days at 70° C. Once dry, the crude treated pigment was ground to a fine powder using a commercial coffee grinder resulting in sulfanilic acid treated Pigment Yellow 74, H+ form.

### B. Preparation of Modified Pigment (D2)

Using an analogous procedure as that detailed in Example 4A and substituting Dowex Monosphere 99Ca/320 (calcium ion exchange resin) for the Amberlite IRN-77 acidic resin (Supelco), sulfanilic acid treated Pigment Yellow 74, Ca++ form was prepared.

### C. Preparation of Modified Pigment (D3)

To 994 g of Cab-O-Jet® 270Y dispersion (Cabot Corporation) at 10% solids was added 9.4 g of ZnCl₂ and the mixture was allowed to stir overnight using simple overhead mixing. The sample was centrifuged at 4100 rpm at 30 min and the supernatant was decanted off. To the crude centrifuged pigment cake was added deionized water. The centrifugation cleaning procedure was repeated until the supernatant conductivity after centrifugation was <500 μs/cm. The crude pigment cake was then placed in a heat-resistant glass tray and dried for 1-2 days at 70° C. Once dry, the crude treated pigment was ground to a fine powder using a commercial coffee grinder resulting in sulfanilic acid treated Pigment Yellow 74, Zn++ form.

### D. Preparation of Modified Pigment (D4)

Using an analogous procedure as that detailed in Example 4C and substituting CuCl₂ for ZnCl₂, sulfanilic acid treated Pigment Yellow 74, Cu++ form was prepared.

### E. Preparation of Dispersion

### Skandex Milling of Polymer with Modified Pigment Yellow 74 (Cu++Form, Sample D4)

10 g of sulfanilic acid modified Pigment Yellow 74 (Cu++counter ion, sample D4), 3.75 g Jeffamine M-2070, and 36.250 g ethyl acetate as solvent were metered into a 250 ml stainless steel paint can. To this was added 60 g of 2 mm glass beads, and a dispersion was prepared by mixing for six hours on a Skandex mixer. The resulting dispersion was very fluid and easily filterable. The glass beads were removed using a Gerson 2000™ fine mesh (190 micron) paint filter. The mean volume particle size (mV) of the particulate material in the dispersion was measured using a Microtrac® Particle Size Analyzer and found to be 0.1551 μm, 0.1428 μm d50, 0.2851 μm d95. An analogous procedure was run for sulfanilic acid treated PY74 with H+, Na+, Ca++, and Zn++ counter ions (see table below).

| Counter | | Mv | 50% | 95% |
|---|---|---|---|---|
| ion | Polymer | (μm) | (μm) | (μm) |
| H+ | none | 0.726 | 0.692 | 1.152 |
| H+ | Jeffamine M- | 0.1434 | 0.1388 | 0.2437 |
| | 2070 | | | |
| Na+ | none | 1.519 | 1.172 | 3.69 |
| Na+ | Jeffamine M- | 1.733 | 1.724 | 2.116 |
| | 2070 | | | |
| Ca++ | none | 1.201 | 1.119 | 1.938 |
| Ca++ | Jeffamine M- | 1.159 | 1.082 | 2.430 |
| | 2070 | | | |
| Zn++ | Jeffamine M- | 0.1406 | 0.1357 | 0.2462 |
| | 2070 | | | |
| Cu++ | none | 1.284 | 1.176 | 2.518 |
| Cu++ | Jeffamine M- | 0.1551 | 0.1428 | 0.2851 |
| | 2070 | | | |

### F. Comparative Example D5

### Skandex Milling Surface Modified Pigment Yellow 74 (PY74) in the Absence of a Polymeric Dispersant (Cu++Form)

10 g of sulfanilic acid modified Pigment Yellow 74 (Cu++counter ion) and 40 g Ethyl Acetate as solvent were metered into a 250 ml stainless steel paint can. To this was added 60 g of 2 mm glass beads, and a dispersion was prepared by mixing for six hours on a Skandex mixer. The resulting dispersion was viscous and difficult to filter. The glass beads were removed using a Gerson 2000™ fine mesh (190 micron) paint filter. The mean volume particle size (mV) of the particulate material in the dispersion was measured using a Microtrac® Particle Size Analyzer and found to be 1.284 μm, 1.176 μm d50, 2.518 μm d95.

### Example 5

### Direct Diazonium Attachment of Polymers

### A. Preparation of Polymer Modified Pigment (E1)

50 g R330 was added to 500 g of a mixed solution of ethanol/water (50/50) and allowed to stir using simple overhead mixing. In a separate 500 ml glass beaker, 56.4 g of Jeffamine XTJ 623 (aniline terminated analog of Jeffamine M-2005, 0.564 mmol/g R330=28.2 mmol) was added to 200 g of a mixed solution of ethanol/water (50/50) and mixed on a stir plate. To this solution was then added 2 ml of methanesulfonic acid (31 mmol) and after 15 min of stirring with acid, 1.95 g of sodium nitrite (28.2 mmol) was slowly added to the solution to convert the aniline moiety to the diazonium salt. After 15 min of mixing, the diazonium salt of Jeffamine XTJ 623 was slowly added to the R330 slurry in ethanol/water (50/50). The reaction was allowed to proceed at room temperature for 2 hours. After 2 hours, the dispersion in ethanol/water was placed in a heat-resistant glass tray and dried overnight at 100° C. The following day, the crude material was stirred in a large stainless steel beaker containing 1500 g of deionized water. The pH of the slurry was then adjusted to pH 2 and the slurry was allowed to mix for 1-2 hours. After 1-2 hours mixing, the carbon black slurry was filtered and washed with additional volumes of water until the pH of the wash water was >4. After the pH adjustment, the treated carbon black was placed was placed in a heat-resistant glass tray and dried for 1-2 days at 70° C. Thermal Gravimetric Analysis (TGA) of the resulting polymer modified carbon black showed 36.29% polymer attachment after an initial acidic wash.

### B. Preparation of Dispersion

### Skandex Milling of Jeffamine XTJ 623 Modified R330, Diazonium Attachment

13.062 g (at 23.44% polymer attachment, 10 g pigment) of Jeffamine M-2005 (diazonium attached Jeffamine XTJ 623) modified R330 thermally condensed at 165° C. and 36.93 g ethyl acetate as solvent were metered into a 250 ml stainless steel paint can. To this was added 60 g of 2 mm glass beads, and a dispersion was prepared by mixing for six hours on a Skandex mixer. The resulting dispersion was very fluid and easily filterable. The glass beads were removed using a Gerson 2000™ fine mesh (190 micron) paint filter. The mean volume particle size (mV) of the particulate material in the dispersion was measured using a Microtrac® Particle Size Analyzer and found to be 0.112 μm, 0.1046 μm d50, 0.171 μm d95.

### Color Performance:

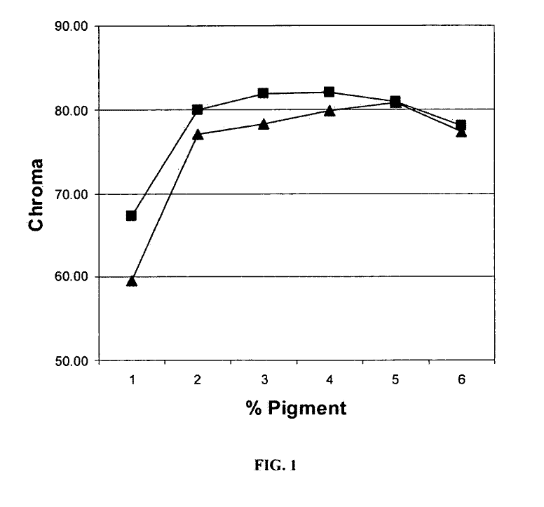

In addition to standard colloidal stability testing (e.g. particle size, viscosity, etc.), the color performance of carbon black and color pigment dispersions in ethyl acetate and polyester resin (Reichold Fine-Tone T-6694 resin) was evaluated. For example, stock solutions of Reichold Fine-Tone T-6694 resin and pigment dispersions in ethyl acetate were prepared and formulated at varying % pigment loadings from 1% to 6% pigment/resin ratios. The resulting formulations were then drawn-down onto BYK-Gardner opacity charts using a 2 mil draw down bar (0.002 inches=50 micron). The resulting films' color performance was then analyzed using a HunterLab spectrophotometer, the results of which are illustrated in FIGS. 1-4.

Films prepared from Jeffamine M-2070 APSES PR122 exhibit better color performance than unmodified PR122 samples with conventional dispersant Solsperse 32500. As generally illustrated in FIG. 1, direct attachment of the polymer to the pigment surface yields larger chroma values at lower % pigment loadings. Points represented by squares “▪” indicate data points for the Jeffamine M-2070 APSES PR 122 polymer modified pigment while points represented by triangles “▴” indicate data points for the unmodified PR 122 with Solsperse 32500.

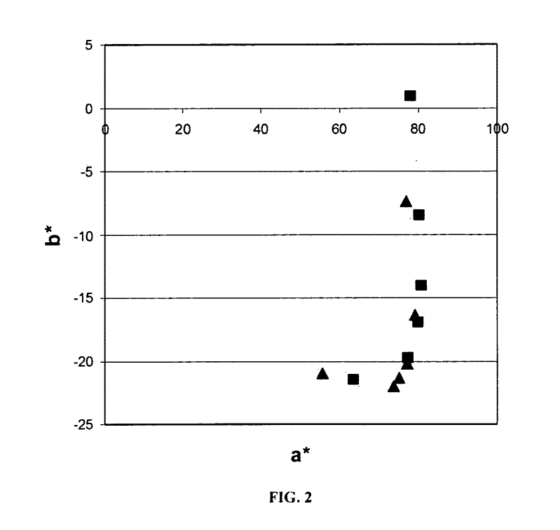

In addition to improved chroma, direct attachment of polymer to the pigment surface improves color gamut as generally illustrated in FIG. 2. The Jeffamine M-2070 APSES-PR 122 magenta dispersions (data points shown as squares “▪”) are able to access much warmer tones of magenta (yellow shade), not possible with conventional dispersants such as the unmodified PR122 with Solsperse 32500 (data points shown as triangles “▴”).

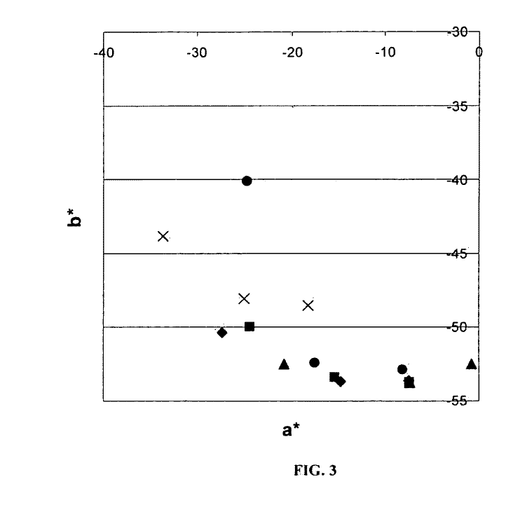

Turning now to FIG. 3, analagous to the results observed with PR122, Jeffamine M-2070 APSES PB15:3 (samples B1, B2 and A1) cyan dispersions improve color gamut by being able to access the most neutral tones of cyan (negligible a* contribution), not possible with unmodified PB 15:3 Solsperse 32500 containing dispersions. In FIG. 3, data points for sample B1 are represented by diamonds, “♦;” data points for sample B2 are represented by triangles, “▴;” and data points for sample A1 are represented by an “X.” Data points for PB 15:3 and non-covalently attached Jeffamine M-2070 (sulfanilic acid) are represented by circles “.” Data points for undmodified PB 15:3 with Solsperse 32500 is represented by squares “▪” As with the PR 122 pigment, direct attachment of the polymer to the pigment affords the ability to match unmodified PB 15:3 Solsperse 32500 dispersions chroma values at lower % pigment loadings. For example, Jeffamine M-2070 APSES PB15:3 (B2) cyan dispersion at 4% pigment and unmodified PB 15:3 Solsperse 32500 containing dispersions at 6% pigment loadings have similar color performance. Thus, Jeffamine M-2070 APSES PB 15:3 (B2) cyan dispersions allow one to access the same color performance with 2% less pigment.

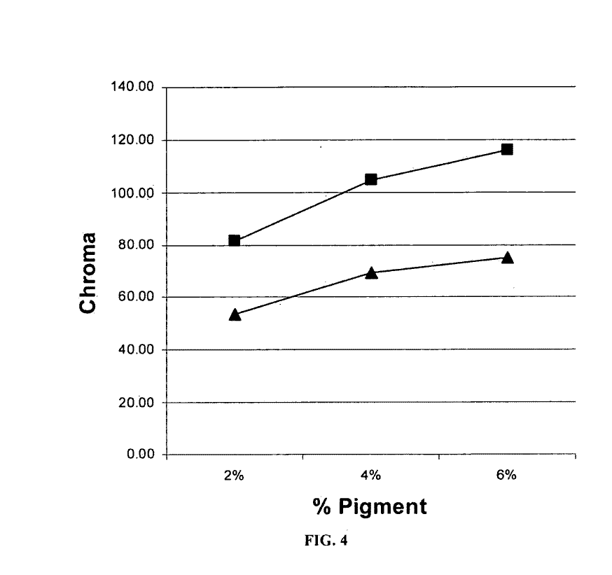

As illustrated in FIG. 4, it has been found that non-covalently bonded Jeffamine M-2070 (sulfanilic acid) PY74 dispersions (squares “▪”) show a dramatic chroma improvement of almost 40 units over a range of pigment loadings (2-6% pigment) compared with a conventional dispersant sample of unmodified PY74 Solsperse 32500 (triangles, “▴”) resulting in brighter, more vivid films.

### Resin Compatibility:

In addition to standard colloidal stability testing and color performance testing, compatibility between the surface modified carbon blacks and color pigments and a host polyester resin (Reichold Fine-Tone T-6694 resin) was evaluated. For example, stock solutions of Reichold Fine-Tone T-6694 resin and pigment dispersions in ethyl acetate were prepared and formulated at 1% pigment/resin ratios. The resulting formulations were then drawn-down onto glass microscopes slides using a 2 mil draw down bar (0.002 inches=50 micron). The resulting films' uniformity and pigment compatibility in the resin matrix was then analyzed using optical microscopy (Olympus BX51 optical microscope). The compatibility results of the aforementioned surface modified pigments in a host polyester resin system as generally illustrated in FIGS. 5-11.

For example, FIG. 5 illustrates the compatibility results of Regal 330-Sulfanilic Acid (acidic form) with Jeffamine M-2070 (1% polymer modified pigment in Reichold Fine Tone T-6694 polyester resin).

For example, FIG. 6 illustrates the compatibility results of Pigment Blue 15:4-APSES-Jeffamine M-2070 (1% polymer modified pigment in Reichold Fine Tone T-6694 polyester resin).

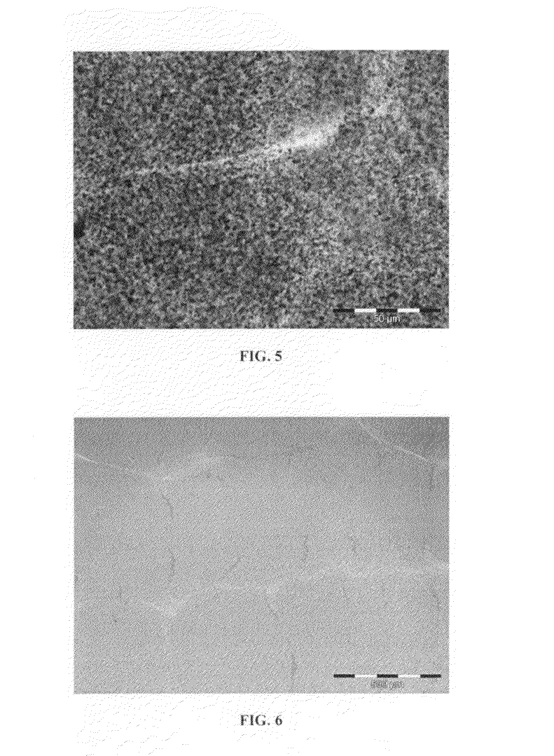

For example, FIG. 7 illustrates the compatibility results of Pigment Red PR122-APSES-Jeffamine M-2005 (1% polymer modified pigment in Reichold Fine Tone T-6694 polyester resin).

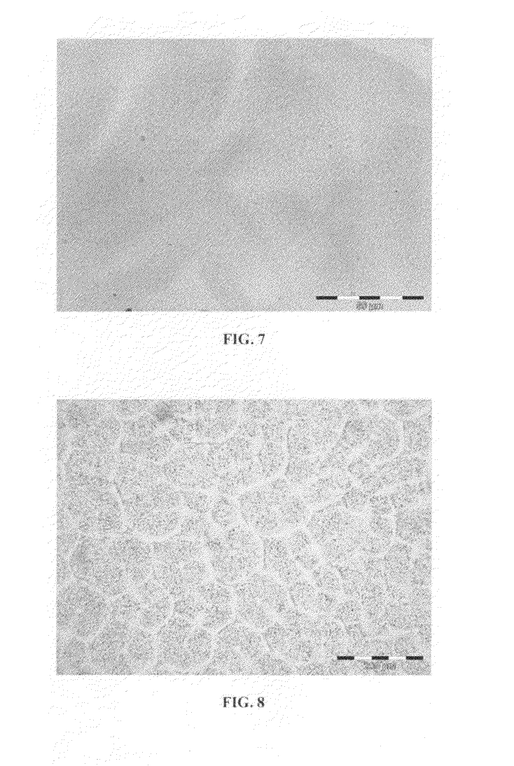

For example, FIG. 8 illustrates the compatibility results of Pigment Yellow 74-APSES-Jeffamine M-2005 (1% polymer modified pigment in Reichold Fine Tone T-6694 polyester resin).

For example, FIG. 9 illustrates the compatibility results of Regal 330-p-aminobenzoic acid (acidic form) thermal condensed with Jeffamine M-2005 (165° C.), 1% polymer modified pigment in Reichold Fine Tone T-6694 polyester resin).

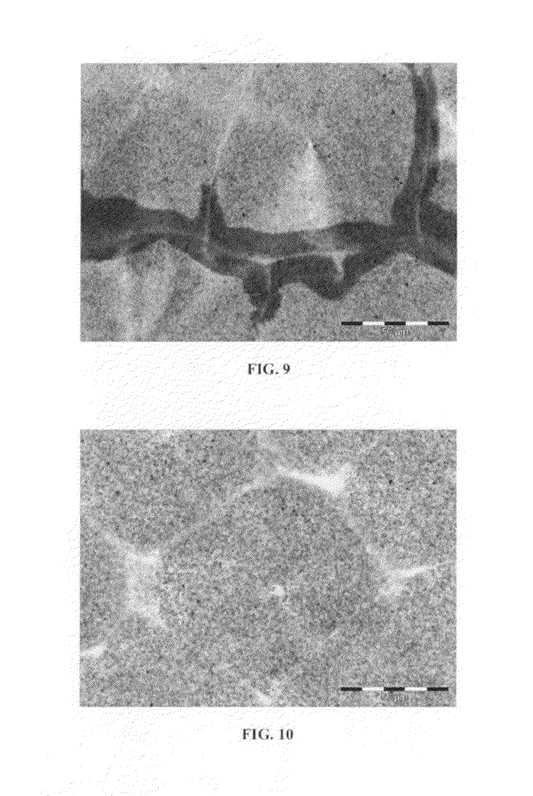

For example, FIG. 10 illustrates the compatibility results of Regal 330-p-aminobenzoic acid (acidic form) thermal condensed with Jeffamine M-2070 (165° C.), 1% polymer modified pigment in Reichold Fine Tone T-6694 polyester resin).

For example, FIG. 11 illustrates the compatibility results of Jeffamine XTJ 623 modified R330 (direct diazonium attachment), 1% polymer modified pigment in Reichold Fine Tone T-6694 polyester resin).

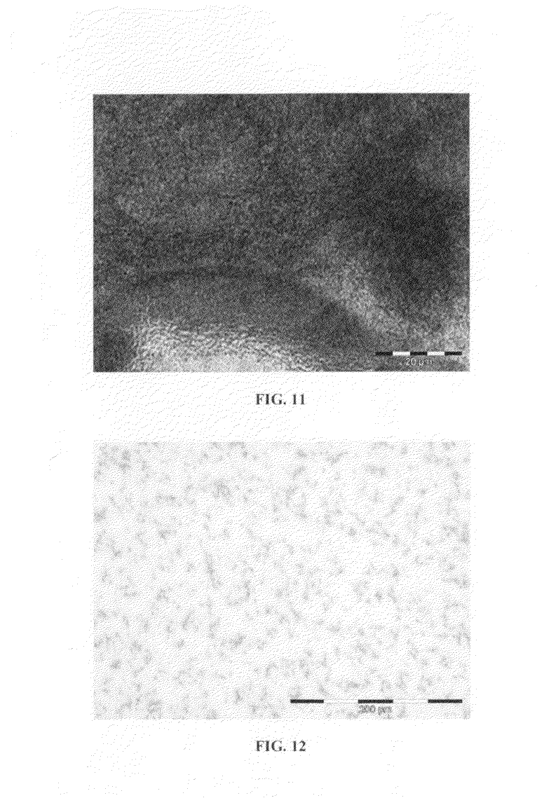

In contrast, FIGS. 12-14 illustrate comparative examples. For example, FIG. 12 is a comparative example illustrating the compatibility results of untreated Pigment Red 122 with conventional dispersant (Solsperse 32500-Lubrizol), 1% polymer modified pigment in Reichold Fine Tone T-6694 polyester resin).

FIG. 13 is a comparative example illustrating the compatibility results of untreated Pigment Blue 15:4 with styrene acrylic copolymer (Joncryl 586-BASF polymers), 2% polymer modified pigment in Reichold Fine Tone T-6694 polyester resin).

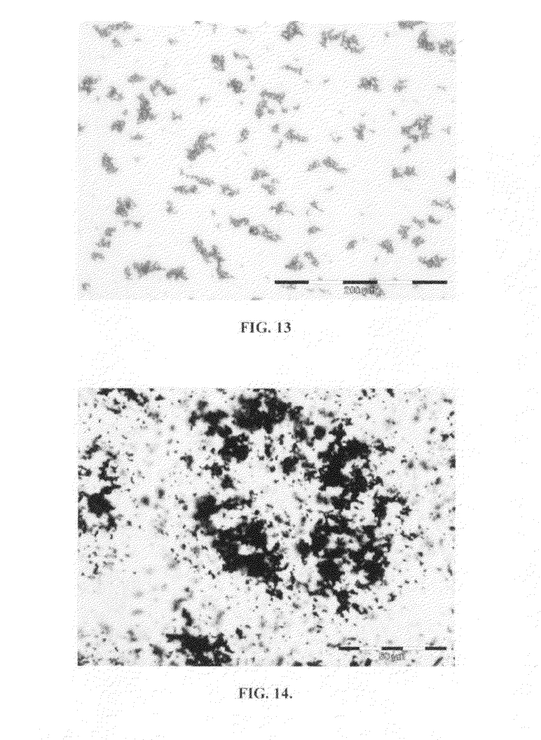

FIG. 14 is a comparative example illustrating the compatibility results of Regal 330-p-aminobenzoic acid (acidic form) thermal condensed with Jeffamine M-2005 (70° C.), 1% polymer modified pigment in Reichold Fine Tone T-6694 polyester resin).

Polymerically modified pigment formulations consistent with embodiments of the present disclosure (e.g., FIGS. 5-11) show better overall compatibility in the polyester films. In all cases, the polymer modified pigments are well-dispersed and not agglomerated. Comparative examples tested with conventional dispersants (e.g., FIGS. 12-14) showed poor dispersion in the polyester film as evidenced by the appearance of large agglomerates in the films and poor dispersion alone in ethyl acetate with particle sizes >300 nm. In contrast, polymer stabilized pigments consistent with the present disclosure have been shown to have excellent dispersion properties alone in solvent (e.g., particle sizes <200 nm).

The foregoing description of preferred embodiments of the present invention has been presented for the purposes of illustration and description. It is not intended to be exhaustive or to limit the invention to the precise form disclosed. Modifications and variations are possible in light of the above teachings, or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A chemical toner composition comprising a resin and a polymer modified pigment comprising a pigment having attached at least one polymeric group, wherein the polymer modified pigment comprises the reaction product of
a) a modified pigment comprising the pigment having attached at least one organic group, wherein the organic group comprises at least one first functional group, and
b) at least one polymer comprising at least one second functional group, wherein the first functional group of the modified pigment and the second functional group of the polymer react to form the polymer modified pigment.

2. The chemical toner composition of claim 1, wherein
i) the first functional group of the modified pigment is an electrophilic group and the second functional group of the polymer is a nucleophilic group, or
ii) the first functional group of the modified pigment is a nucleophilic group and the second functional group of the polymer is an electrophilic group.

3. The chemical toner composition of claim 2, wherein the first functional group of the modified pigment is an electrophilic group and the second functional group of the polymer is a nucleophilic group.

4. The chemical toner composition of claim 2, wherein the first functional group of the modified pigment is a nucleophilic group and the second functional group of the polymer is an electrophilic group.

5. The chemical toner composition of claim 2, wherein the first functional group of the modified pigment and the second functional group of the polymer are independently selected from the group consisting of: a carboxylic acid; an ester; an acid chloride; a sulfonyl chloride; an acyl azide; an isocyanate; a ketone; an aldehyde; an anhydride; an amide; an imide; an imine; an α,β-unsaturated ketone, aldehyde, or sulfone; an alkyl halide; an epoxide; an alkyl sulfonate or sulfate; an aromatic compound which is capable of undergoing an addition-elimination reaction; an amine; a hydrazine; an alcohol; a thiol; a hydrazide; an oxime; a triazene; a carbanion; and a salt or derivative thereof.

6. The chemical toner composition of claim 2, wherein the first functional group of the modified pigment and the second functional group of the polymer react to form an addition-elimination product between the modified pigment and the polymer.

7. The chemical toner composition of claim 6, wherein the first functional group of the modified pigment is an alkyl sulfate group and the second functional group of the polymer is an amino group.

8. The chemical toner composition of claim 7, wherein the alkyl sulfate group is a (2-sulfatoethyl)-sulphone group.

9. The chemical toner composition of claim 1, wherein the organic group is a phenyl-(2-sulfatoethyl)-sulphone group.

10. The chemical toner composition of claim 2, wherein the first functional group of the modified pigment and the second functional group of the polymer react to form a condensation product between the modified pigment and the polymer.

11. The chemical toner composition of claim 10, wherein the first functional group of the modified pigment is an amino group and the second functional group of the polymer is a carboxylic acid group, and wherein the condensation product is an amide.

12. The chemical toner composition of claim 10, wherein the first functional group of the modified pigment is a carboxylic acid group and the second functional group of the polymer is an amino group, and wherein the condensation product is an amide.

13. The chemical toner composition of claim 10, wherein the first functional group of the modified pigment is an alcohol group and the second functional group of the polymer is a carboxylic acid group, and wherein the condensation product is an ester.

14. The chemical toner composition of claim 10, wherein the first functional group of the modified pigment is a carboxylic acid group and the second functional group of the polymer is an alcohol group, and wherein the condensation product is an ester.

15. The chemical toner composition of claim 1, wherein
i) the first functional group of the modified pigment is an anionic or anionizable group and the second functional group of the polymer is a cationic or cationizable group, or
ii) the first functional group of the modified pigment is a cationic or cationizable group and the second functional group of the polymer is an anionic or anionizable group.

16. The chemical toner composition of claim 15, wherein the first functional group of the modified pigment is cationizable and the second functional group of the polymer is anionizable.

17. The chemical toner composition of claim 15, wherein the first functional group of the modified pigment is anionizable and the second functional group of the polymer is cationizable.

18. The chemical toner composition of claim 15, wherein the first functional group of the modified pigment and the second functional group of the polymer react to form a salt between the modified pigment and the polymer.

19. The chemical toner composition of claim 18, wherein the first functional group of the modified pigment is a sulfonic acid group or a carboxylic acid group and the second functional group of the polymer is an amino group, and wherein the salt is an ammonium salt.

20. The chemical toner composition of claim 18, wherein the first functional group of the modified pigment is an amino group and the second functional group of the polymer is a sulfonic acid group or a carboxylic acid group, and wherein the salt is an ammonium salt.

21. The chemical toner composition of claim 1, wherein the polymer is an amine-terminated polymer.

22. The chemical toner composition of claim 1, wherein the polymer is an amine-terminated polyalkylene oxide.

23. The chemical toner composition of claim 1, wherein the polymer is the resin.

24. A chemical toner composition comprising a resin and a polymer modified pigment comprising a pigment having attached at least one polymeric group, wherein the polymer modified pigment comprises the combination product of
a) a modified pigment comprising the pigment having attached at least one organic group, wherein the organic group comprises at least one first functional group, and
b) at least one polymer comprising at least one second functional group, wherein the first functional group of the modified pigment and the second functional group of the polymer coordinate with each other to form the polymer modified pigment and wherein
i) the first functional group of the modified pigment is an anionic group and the second functional group of the polymer is a cationizable group, or
ii) the first functional group of the modified pigment is a cationizable group and the second functional group of the polymer is an anionic group.

25. The chemical toner composition of claim 24, wherein the first functional group of the modified pigment and the second functional group of the polymer coordinate to form an associated ion pair between the modified pigment and the polymer.

26. The chemical toner composition of claim 24, wherein the first functional group of the modified pigment is a sulfonic acid salt group and the second functional group of the polymer is an amino group.

27. The chemical toner composition of claim 24, wherein the sulfonic acid salt group has the formula —SO₃⁻M⁺, wherein M⁺ is Na⁺, K⁺, Li⁺, Cs⁺, Ca⁺², Cu⁺², Zn⁺², Fe⁺², Fe⁺³, or Zr⁺⁴.

28. The chemical toner composition of claim 24, wherein the polymer is an amine-terminated polymer.

29. The chemical toner composition of claim 24, wherein the polymer is an amine-terminated polyalkylene oxide.

30. The chemical toner composition of claim 24, wherein the polymer is the resin.

31. A chemical toner composition comprising a resin and a polymer modified pigment comprising a pigment having attached at least one polymeric group, wherein the polymeric group has the formula -X-Z-[PAO]-R, wherein X, which is directly attached to the pigment, is an arylene or heteroarylene group; Z is NR′ or O and R′ is H, a C1-C18 alkyl group, a C1-C18 acyl group, an aralkyl group, an alkaryl group, or an aryl group; PAO is a polyalkylene oxide group; and R is H, a substituted or unsubstituted alkyl group, or a substituted or unsubstituted aromatic group.

32. The chemical toner of claim 31, wherein X is an arylene group.

33. The chemical toner composition of claim 31, wherein the PAO is a copolymer of ethylene oxide and propylene oxide.

34. The chemical toner composition of claim 31, wherein Z is NH.
